(19) United States
(12) Patent Application Publication
(10) Pub. No.: US 2010/0208768 A1
(43) Pub. Date: Aug. 19, 2010

(54) TEMPERATURE MONITORING DEVICE FOR HIGH-VOLTAGE AND MEDIUM-VOLTAGE COMPONENTS

(75) Inventors: Martin Lakner, Gebenstorf (CH); Roman Eberle, Winterthur (CH); Tilo Buehler, Wettingen (CH); Daniel Chartouni, Wettingen (CH); Peter Unternaehrer, Wuerenlos (CH); Arthur Suess, Oetwil am See (CH); Jean-Claude Mauroux, Hunzenschwil (CH)

Correspondence Address: BUCHANAN, INGERSOLL & ROONEY PC, POST OFFICE BOX 1404, ALEXANDRIA, VA, 22313-1404, US

(73) Assignee: ABB Technology AG, Zuerich (CH)

(21) Appl. No.: 12/771,648

(22) Filed: Apr. 30, 2010

Related U.S. Application Data
(63) Continuation of application No. PCT/EP2008/064195, filed on Oct. 21, 2008.

(30) Foreign Application Priority Data
Oct. 31, 2007 (EP) 07119694.3

(51) Int. Cl. G01K 5/62; G01K 5/48

(52) U.S. Cl. 374/206; 374/187; 374/E05.03; 374/E05.037

(57) ABSTRACT

A temperature monitoring apparatus for high-voltage or medium-voltage components has a transducer which can produce a mechanical signal, which is dependent on the temperature of the component to be monitored. The mechanical signal is transmitted to an electrically isolating transmission element, for example in the form of a rod, and from the transmission element to a movement sensor. The transmission element can be arranged in an electrically isolating hollow body. This arrangement allows the movement sensor to be isolated from high voltages. The apparatus is composed of robust components, and can have a long life.

### RELATED APPLICATIONS

This application claims priority as a continuation application under 35 U.S.C. §120 to PCT/EP2008/064195, which was filed as an International Application on Oct. 21, 2008 designating the U.S., and which claims priority to European Application 07119694.3 filed in Europe on Oct. 31, 2007. The entire contents of these applications are hereby incorporated by reference in their entireties.

### FIELD

The present disclosure relates to a temperature monitoring apparatus for high-voltage and medium-voltage components.

### BACKGROUND INFORMATION

Infrared sensors are used to monitor the temperature of medium-voltage and high-voltage components. Such infrared sensors allow the temperature of the component to be measured contactlessly and from a distance, thus allowing safe potential isolation, even in the event of high lightning-strike voltages. However, infrared sensors have a restricted life of, for example, five years. A longer life is desirable, in order to reduce the operating costs.

SE469611 B discloses a temperature monitoring unit for measurement of the temperature in a low-voltage system, wherein the temperature is measured at a different point than the point where a tripping unit is operated. In this temperature monitoring unit, a temperature sensor uses a spring composed of a metal with a memory effect. The movement of the spring at a critical temperature is transmitted by means of a flexible and electrically isolating Bowden cable to a control box which is at ground potential. A flexibly deformable, and therefore movable, isolator which extends between one potential and ground potential can cause inhomogeneities in the electrical field. Electrical field inhomogeneities such as these should be avoided, particularly in the field of medium-voltage and high-voltage applications.

GB 2021265 discloses a temperature monitoring mechanism which permits an electrical heating boiler or a space heater to be controlled. The temperature sensor for the heating boiler is subject to the pressure of the steam boiler, while the switch for switching off the heating element is located remotely from the point where the steam is produced. In order to transmit to the switch the switching-off signal that is produced at the point where the pressure is present in the steam boiler, a Bowden cable or a fluid located in a capillary tube is used to ensure correct operation of the tripping device away from the point where the steam is produced.

EP 1657731 describes a generator switch which includes a coupled heat pipe to cool the inner conductor, which is at an electrical potential. An electrical isolation gap and a flexibly deformable section are provided to mechanically and electrically decouple the evaporator and the condenser of the heat pipe.

### SUMMARY

An exemplary embodiment provides a temperature monitoring apparatus for measurement of the temperature of a medium-voltage or high-voltage component. The exemplary temperature monitoring apparatus includes a transducer configured to produce a mechanical signal, which is dependent on the temperature of the high-voltage or medium-voltage component, and a movement sensor which is arranged at a distance and electrically isolated from the transducer. The exemplary temperature monitoring apparatus also includes a non-conductive transmission element which extends between the transducer and the movement sensor. The transmission element is configured to be caused to move by the mechanical signal produced by the transducer, and the movement sensor is configured to be operated by the movement of the transmission element. The transmission element is a rod which extends in a substantially straight line and is configured to transmit at least one of a tensile, shock and torsion movement.

An exemplary embodiment provides a temperature monitoring apparatus for measurement of the temperature of a medium-voltage or high-voltage component. The exemplary temperature monitoring apparatus includes a transducer configured to produce a mechanical signal, which is dependent on the temperature of the high-voltage or medium-voltage component, and a movement sensor which is arranged at a distance and electrically isolated from the transducer. The exemplary temperature monitoring apparatus also includes a non-conductive transmission element which extends between the transducer and the movement sensor. The transmission element is configured to be caused to move by the mechanical signal produced by the transducer. The movement sensor is configured to be operated by the movement of the transmission element. The transmission element is arranged in an isolating hollow body. The transducer is arranged at a first end of the hollow body and the movement sensor is arranged at a second end of the hollow body, which extends substantially straight along the transmission element and is fitted with the movement sensor. The transmission element is one of in the form of a rod and includes a plurality of solid individual bodies which are arranged in one or more rows with respect to one another and which are configured to move longitudinally.

### BRIEF DESCRIPTION OF THE DRAWINGS

Additional refinements, features, advantages and applications of the present disclosure are described in more detail below with reference to exemplary embodiments illustrated in the drawings, in which:

FIG. 1 shows a first exemplary embodiment of a temperature monitoring apparatus,

FIG. 2 shows a second exemplary embodiment of a temperature monitoring apparatus,

FIG. 3 shows a third exemplary embodiment of a temperature monitoring apparatus,

FIG. 4 shows a fourth exemplary embodiment of a temperature monitoring apparatus,

FIG. 5 shows a fifth exemplary embodiment of a temperature monitoring apparatus, and

FIG. 6 shows a sixth exemplary embodiment of a temperature monitoring apparatus.

### DETAILED DESCRIPTION

Exemplary embodiments of the present disclosure provide a long-life temperature monitoring apparatus for high-voltage and medium-voltage, components.

According to an exemplary embodiment, the temperature monitoring apparatus includes a transducer, which produces (i.e., generates) a mechanical signal which is dependent on the temperature of a high-voltage or medium-voltage component. This signal can be in the form of a macroscopic or microscopic movement which, for example, may be a tensile, shock or torsion movement. Furthermore, a movement sensor, which can be, for example, a mechanical switch configured to convert a movement to an electrical signal, is arranged at a distance and electrically isolated from the transducer. A non-conductive transmission element extends between the transducer and the movement sensor. The mechanical signal from the transducer produces a movement of the transmission element, by means of which the movement sensor can be operated.

This arrangement has the advantage that long-life components of simple design can be used. It is therefore possible to achieve a desired long life.

By way of example, the transmission element may be in the form of a stiff, isolating rod, which transmits a shock or tensile movement of the transducer to the movement sensor.

The transmission element may also include a multiplicity of solid individual bodies, for example spheres, which are arranged in one or more rows with respect to one another, and which transmit the movement to the movement sensor.

The temperature monitoring apparatus is exemplarily suitable for monitoring the temperature of a component which is at a voltage of, for example, about 1 kV or more (e.g., 12.5 kV or more), and can be withstand lightning strike voltages of up to 150 kV without any deleterious effects.

The temperature monitoring apparatus according to the illustrated exemplary embodiments includes a transducer 1 which is arranged at a first end of the apparatus, a movement sensor 2 which is arranged at a second end of the apparatus, opposite the first end of the apparatus, and a transmission element 3 which extends between the transducer 1 and the movement sensor 2.

During operation, the transducer 1 makes thermal contact with a component 4 to be monitored, such as a high-voltage or medium-voltage switch, for example. According to an exemplary embodiment, the monitoring apparatus is configured to produce an electrical signal which depends on the temperature of the monitored component 4. By way of example, the signal may be a binary signal, which indicates whether the temperature of the component 4 has exceeded a predetermined temperature threshold. Alternatively, the signal may be, for example, an analog signal, such as a voltage value, for example, which varies essentially without any discontinuities with the temperature of the component 4.

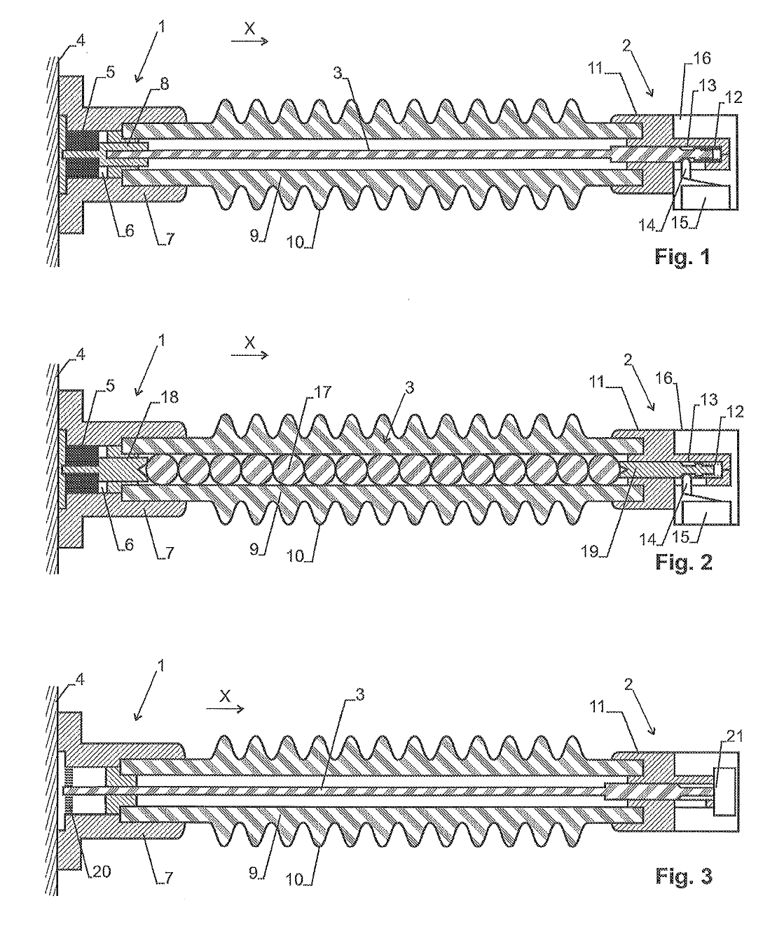

In the exemplary embodiment shown in FIG. 1, the transducer 1 includes one or more snap-action disks 5 which are stacked one on top of the other. The snap-action disks 5 are disks which assume a first shape or a second shape depending on the temperature of the component 4, as a result of which the height of the stack varies in the direction X in FIG. 1. Snap-action disks 5 such as these can be, for example, composed of a bimetallic strip and/or a shape-memory alloy.

The stack of snap-action disks 5 is arranged in a chamber 6 in a foot 7 of the monitoring apparatus. The foot 7 makes direct thermal contact with the component 4 to be monitored.

A holder 8 is supported on the snap-action disks 5, is mounted in the foot 7 such that the holder 8 can move in the direction X, and is supported against a first end of the transmission element 3 which, in the exemplary embodiment illustrated in FIG. 1, is in the form of a stiff, straight rod. The transmission element 3 can be composed of an insulating, voltage-resistant material, and is arranged in a hollow body 9. The hollow body 9 can also composed of a stiff, insulating, voltage-resistant material. On its outside, the hollow body 9 has isolation ribs 10 which can increase the creepage distance.

The foot 7 and the transducer 1 are arranged at a first end of the hollow body 9. The foot 7 is firmly connected to the hollow body 9. At the opposite, second end, the hollow body 9 has a head 11 of the monitoring apparatus, on which the movement sensor 2 is arranged.

The transmission element 3 is mounted in the head 11 such that the transmission element 3 can move in the direction X. A compression spring 12 is arranged between the head 11 and the second end of the transmission element 3, and presses the transmission element 3 against the snap-action disks 5 in a direction opposite the direction X.

A groove 13, in which a finger 14 of a microswitch 15 engages, runs along the outside of the transmission element 3, close to the second end. These parts form the movement sensor 2. The microswitch 15 is attached to the head 11 via a holder 16.

In the exemplary embodiment shown in FIG. 1, the hollow body 9 is stiff and is firmly connected to the foot 7 and to the head 11. This makes it possible to install the entire apparatus, by the foot 7 being mounted on the component 4 by suitable attachment means, while the head 11 is held such that the head 11 is free and does not touch further parts of the hollow body 9. With this exemplary installation, the monitoring apparatus is not subject to any excessive mechanical loads during movement and vibration of the component 4.

In order to isolate the head 11 and the components arranged on the head 11, and to withstand lightning strike voltages of up to 150 kV, for example, the length of the hollow body 9 and of the transmission element 3 should be, for example, at least 6 cm, (e.g., at least 22 cm). The creepage distance on the outside of the hollow body 9 should be, for example, at least 30 cm long. Since the transmission element 3 which is arranged in the hollow body 9 is protected against environmental influences, there may also not be any need to provide isolation ribs 10 on the transmission element. If the hollow body 9 is sufficiently long, the isolation ribs 10 may be omitted.

The component 4 illustrated in FIG. 1 operates as follows. At a low temperature (e.g., below a predetermined threshold temperature), the monitoring apparatus is in the position shown in FIG. 1, in which the finger 14 engages in the groove 13 and the switch 15 is open. When the temperature of the component 4 rises above a predetermined threshold temperature, then the snap-action disks 5 move to their second position, thus increasing the height of the stack of the snap-action disks 5 in the direction X. This results in a longitudinal force being exerted on the transmission element 3, moving the transmission element 3 against the force of the compression spring 12 in the direction X. The finger 14 is therefore forced out of the groove 13, and the switch 15 is operated. When the temperature of the component 4 falls below the threshold temperature again, then the snap-action disks 5 move back to their first position, the stack of the snap-action disks 5 becomes shorter, and the transmission element 3 is forced back to the position shown in FIG. 1 again, by the compression spring 12, as a result of which the finger 14 falls into the groove 13 again, and the switch 15 is opened.

Depending on the form of the transducer 1, it can exert a tensile force and/or a shock force on the transmission element 3. If the transducer 1 is able to exert both a tensile force and a shock force, then, in some circumstances, the spring 12 may also be omitted. It is also feasible to provide a manual reset or electromagnetic reset, for example, instead of the spring 12.

By way of example, the transducer 1 may also be formed by a spring composed of a shape-memory material which lengthens and/or contracts when the threshold temperature is exceeded, thus operating the transmission element 3.

Instead of a transmission element in the form of a rod, it is also possible to use a transmission element include a plurality of solid individual bodies, for example spheres 17, which are arranged in one or more rows with respect to one another and can move longitudinally, as illustrated in the exemplary embodiment in FIG. 2. A first of the spheres 17 at the first end of the apparatus strikes a first plunger 18, which carries out the role of the holder 8 in the exemplary embodiment shown in FIG. 1. At the other end of the apparatus, a last of the spheres 17 strikes a second plunger 19, which carries out the role of the head end of the transmission element as shown in FIG. 1. For example, the second plunger is supported against the force of the spring 12 and has the groove 13, in which the finger 14 engages, on its outer face.

The operation of the exemplary embodiment shown in FIG. 2 is analogous to that shown in FIG. 1 in that the first plunger 18 forces the spheres 17 against the second plunger 19 when the threshold temperature is exceeded, and moves the second plunger 19 in the direction X, thus operating the switch 15.

Instead of spheres 17, the transmission element 3 may be formed by other solid individual bodies, for example, by a multiplicity of short, cylindrical parts arranged in one or more rows with respect to one another.

In another exemplary embodiment illustrated in FIG. 3, the transmission element 3 is formed by a torsionally stiff rod. This is mounted in the interior of the hollow body 9 such that the transmission element 3 can rotate about its longitudinal axis. In this exemplary embodiment, the transducer 1 is formed by a spiral 20 composed of a bimetallic strip and/or a shape-memory material, which is attached on its external circumference to the foot 7 and is attached in its center to the transmission element 3. When the temperature of the component 4 changes, then the spiral exerts a rotation force on the transmission element 3, and rotates the transmission element 3 about its longitudinal axis.

The transmission element 3 is directly coupled at its second end to the shaft of a rotary potentiometer 21 in the exemplary embodiment shown in FIG. 3. When the temperature of the component 4 changes, then, in the exemplary embodiment shown in FIG. 3, the tapped resistance of the potentiometer 21 is therefore changed such that an analog voltage signal which is dependent on the temperature can be produced by the transducer 1.

Instead of a potentiometer, it is also possible to provide a rotary switch, which produces a binary signal in a similar manner to the exemplary embodiments shown in FIG. 1 or 2. On the other hand, a linear potentiometer can also be used instead of a switch in the exemplary embodiments shown in FIGS. 1 and 2 (and in the embodiments described in the following text).

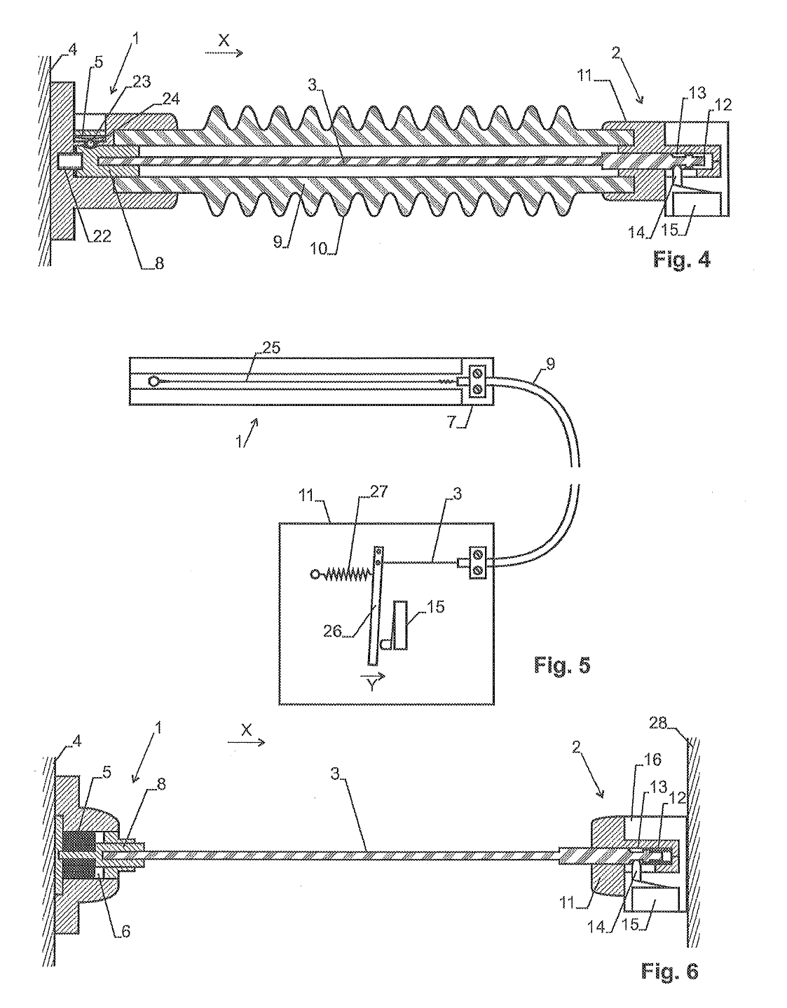

FIG. 4 shows an exemplary embodiment in which a transducer 1 can be used to produce a short mechanical travel and little force. For this purpose, in a similar manner to that in the exemplary embodiment shown in FIG. 1, the transmission element 3 can be in the form of a rod, which can be moved in the direction X and whose second end operates the switch 15. The transmission element 3 is held by the holder 8 at the first end of the apparatus, and the holder 8 is itself held firmly by a locking mechanism against the force of a compression spring 22. A locking mechanism is formed by the transducer 3. A sphere 23 is provided for this purpose, and is pressed by a snap-action disk 5 of the transducer into a depression 24 at the side of the holder 8.

The exemplary embodiment shown in FIG. 4 operates as follows. When the temperature is low (e.g., below a predetermined threshold temperature), the apparatus is in the position shown in FIG. 4. The compression spring 22 is prestressed, and the sphere 23 is pressed into the depression 24 by the snap-action disk 22.

As soon as the threshold temperature is exceeded, the snap-action disk 5 changes its shape, such that the sphere 23 can move back out of the depression 24, thus unlocking the locking mechanism. The compression spring 22 now moves the transmission element 3 in the direction X, thus closing the switch 15.

In order to reset the apparatus, the transmission element 3 can be moved back again manually or by a motorized device once the threshold temperature has been undershot, as a result of which the locking mechanism can latch in again.

As already mentioned, the connection between the transducer 1 and the movement sensor 2 may also be flexible. In this case, it is possible to connect the transducer 1 firmly to the component 4, on the one hand, and on the other hand to connect the movement sensor 2 firmly to, for example, a stationary foundation, without this resulting in excessive mechanical loading of the apparatus.

FIG. 5 shows a corresponding exemplary apparatus, in which the transmission element 3 and the hollow body 9 are flexible. They form a Bowden cable, in that the transmission element 3 is in the form of a tension-resistant cable, for example composed of glass fiber, and the hollow body is in the form of, for example, a flexible plastic tube, which is pressure-resistant in the longitudinal direction.

In this case, the transducer 1 exerts a tensile force on the transmission element 3 at the first end of the apparatus. In the exemplary embodiment shown in FIG. 5, this can be achieved in that the hollow body 9 is attached to the foot 7, and the transmission element 3 is connected to one end of a tension wire 25 composed of shape-memory material. The other end of the tension wire 25 is likewise firmly attached to the foot 7. The foot 7 is connected to the component 4 and forms a housing in which the tension wire 25 is protected, and is kept at the same temperature as the component 4 to be monitored. The length of the tension wire 25 is temperature-dependent.

At the second end of the apparatus, a tensile force is exerted on the transmission element 3, and its longitudinal movement is detected. In the example shown in FIG. 5, this is achieved in that the hollow body 9 is attached to the head 11, and the transmission element 3 is connected to a pivoting lever 26. The pivoting lever 26 is held against the tensile force of the transmission element 3 by a tension spring 27.

When the tension wire 25 contracts when the threshold temperature is exceeded, then the pivoting lever 26 is moved against the force of the tension spring 27 in the direction Y with respect to a switch 15, and operates the switch 15. When the component 4 undershoots the threshold temperature again, then the tension wire 25 is lengthened, and the pivoting lever 26 is moved back, with the switch 15 being opened.

In the exemplary embodiments described so far, the transmission element 3 is guided in a hollow body 9 which (with the exception of the exemplary embodiment shown in FIG. 5) can also be fitted with the movement sensor 2. However, it is also feasible, as illustrated in FIG. 6, to attach the movement sensor 2 to a mount 28, for example a foundation, which is not at high-voltage or medium-voltage and is arranged essentially fixed in position with respect to the component 4 to be monitored. In this case, there is advantageously no need for the hollow body 9 either. If required, the transmission element 3 may be provided with isolation ribs on its outside. Otherwise, the exemplary embodiment shown in FIG. 6 is largely identical to the exemplary embodiment shown in FIG. 1.

The exemplary embodiments of the present disclosure provide a robust and simple capability for measurement or monitoring of the temperature of a medium-voltage or high-voltage module.

The transducer 1 may be designed in many different ways. For example, as mentioned, the transducer 1 may produce an analog, continuous signal, or a binary, non-continuous signal. If a shape-memory alloy is used, then the transducer may be an element with a single-way or two-way effect. Depending on the alloy, continuous (analog) or sudden (digital) deformation is also possible in this case.

The transmission element 3 is configured to transmit a mechanical deflection to the movement sensor, with electrical isolation.

The movement sensor 2 may be in the form of, for example, a push-button or touch switch, or a potentiometer, in any of the above-described exemplary embodiments. If appropriate, a reset mechanism can also be provided. This may be in the form of a normal reset spring, which is also configured to prevent a temperature monitor from being triggered by any vibration during switching (so-called bouncing). Furthermore, resetting is also feasible with the aid of a solenoid, an electric motor or by hand. Depending on the particular embodiment, the movement sensor may also act as a force sensor and may convert a minimal, microscopic movement of the transmission element to an electrical signal.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1: Transducer
2: Movement sensor
3: Transmission element
4: Component to be monitored
5: Snap-action disks
6: Chamber
7: Foot
8: Holder
9: Hollow body
10: Isolation ribs
11: Head
12: Compression spring
13: Groove
14: Finger
15: Microswitch
16: Holder
17: Spheres
18: First plunger
19: Second plunger
20: Bimetallic spiral
21: Potentiometer
22: Compression spring
23: Sphere
24: Depression
25: Tension wire composed of shape-memory material
26: Pivoting lever
27: Tension spring
28: Mount which is not at high voltage

What is claimed is:

1. A temperature monitoring apparatus for measurement of the temperature of a medium-voltage or high-voltage component, the temperature monitoring apparatus comprising:
a transducer configured to produce a mechanical signal, which is dependent on the temperature of the high-voltage or medium-voltage component;
a movement sensor which is arranged at a distance and electrically isolated from the transducer; and
a non-conductive transmission element which extends between the transducer and the movement sensor, the transmission element being configured to be caused to move by the mechanical signal produced by the transducer, wherein:
the movement sensor is configured to be operated by the movement of the transmission element; and
the transmission element is a rod which extends in a substantially straight line and is configured to transmit at least one of a tensile, shock and torsion movement.

2. A temperature monitoring apparatus for measurement of the temperature of a medium-voltage or high-voltage component, the temperature monitoring apparatus comprising:
a transducer configured to produce a mechanical signal, which is dependent on the temperature of the high-voltage or medium-voltage component;
a movement sensor which is arranged at a distance and electrically isolated from the transducer; and
a non-conductive transmission element which extends between the transducer and the movement sensor, the transmission element being configured to be caused to move by the mechanical signal produced by the transducer, wherein:
the movement sensor is configured to be operated by the movement of the transmission element;
the transmission element is arranged in an isolating hollow body;
the transducer is arranged at a first end of the hollow body and the movement sensor is arranged at a second end of the hollow body, the hollow body extending substantially straight along the transmission element and being fitted with the movement sensor; and
the transmission element is one of in the form of a rod and includes a plurality of solid individual bodies which are arranged in one or more rows with respect to one another and which are configured to move longitudinally.

3. The temperature monitoring apparatus as claimed in claim 1, wherein the transmission element is not arranged in a hollow body.

4. The temperature monitoring apparatus as claimed in claim 2, comprising isolation ribs arranged on an outer face of the hollow body.

5. The temperature monitoring apparatus as claimed in claim 1, comprising isolation ribs arranged on an outer face of the transmission element.

6. The temperature monitoring apparatus as claimed in claim 2, wherein the individual bodies are spheres.

7. The temperature monitoring apparatus as claimed in claim 1, wherein the transducer is configured to exert at least one of a shock force and tensile force on the transmission element.

8. The temperature monitoring apparatus as claimed in claim 1, wherein the transducer has at least one spring composed of at least one of a shape-memory material and snap-action disk, which assume a first shape and a second shape depending on the temperature of the component.

9. The temperature monitoring apparatus as claimed in claim 1, wherein the transducer is configured to exert a rotation force on the transmission element, and the transducer has a spiral composed of at least one of a bimetallic strip and a shape-memory material.

10. The temperature monitoring apparatus as claimed in claim 1, wherein the transducer forms a locking mechanism, which holds the transmission element firmly against a force, and is configured to be unlocked if a threshold temperature is exceeded.

11. The temperature monitoring apparatus as claimed in claim 1, wherein the movement sensor is one of a switch configured to be operated by the transmission element, a potentiometer configured to be operated by the transmission element.

12. The temperature monitoring apparatus as claimed in claim 1, wherein the temperature monitoring apparatus is configured to monitor the temperature of a component which is at a voltage of about 1 kV or greater.

13. The temperature monitoring apparatus as claimed in claim 3, comprising isolation ribs arranged on an outer face of the transmission element.

14. The temperature monitoring apparatus as claimed in claim 4, wherein the individual bodies are spheres.

15. The temperature monitoring apparatus as claimed in claim 2, wherein the transducer is configured to exert at least one of a shock force and tensile force on the transmission element.

16. The temperature monitoring apparatus as claimed in claim 2, wherein the transducer has at least one spring composed of at least one of a shape-memory material and snap-action disk, which assume a first shape and a second shape depending on the temperature of the component.

17. The temperature monitoring apparatus as claimed in claim 2, wherein the transducer is configured to exert a rotation force on the transmission element, and the transducer has a spiral composed of at least one of a bimetallic strip and a shape-memory material.

18. The temperature monitoring apparatus as claimed in claim 2, wherein the transducer forms a locking mechanism, which holds the transmission element firmly against a force, and is configured to be unlocked if a threshold temperature is exceeded.

19. The temperature monitoring apparatus as claimed in claim 2, wherein the movement sensor is one of a switch configured to be operated by the transmission element, a potentiometer configured to be operated by the transmission element.

20. The temperature monitoring apparatus as claimed in claim 12, wherein the temperature monitoring apparatus is configured to monitor the temperature of a component which is at a voltage of about 12.5 kV or greater.

21. The temperature monitoring apparatus as claimed in claim 2, wherein the temperature monitoring apparatus is configured to monitor the temperature of a component which is at a voltage of about 1 kV or greater.

22. The temperature monitoring apparatus as claimed in claim 21, wherein the temperature monitoring apparatus is configured to monitor the temperature of a component which is at a voltage of about 12.5 kV or greater.
